(19) United States
(12) Patent Application Publication
(10) Pub. No.: US 2017/0111485 A1
(43) Pub. Date: Apr. 20, 2017

(54) REMOVABLE DEVICE CASE

(71) Applicant: SAMYANG CNS Co., Ltd., Gyeonggi-do (KR)

(72) Inventor: Sung-Jun KIM, Gyeonggi-do (KR)

(73) Assignee: SAMYANG CNS Co., Ltd., Gyeonggi-do (KR)

(21) Appl. No.: 15/073,160

(22) Filed: Mar. 17, 2016

(30) Foreign Application Priority Data
Oct. 19, 2015 (KR) 10-2015-0145648

(51) Int. Cl. H04M 1/02; H04M 1/04

(52) U.S. Cl. CPC H04M 1/0237; H04M 1/04; H04M 1/0297

(57) ABSTRACT

Disclosed herein is a removable device case in which a plurality of rails formed in a main body thereof is assembled to a sliding coupling member such that the case can be completely combined. The removable device case can easily hold a device by coupling a rail part formed on one surface of the main body to a separate coupling member. In addition, disclosed herein is a case coupling structure that enables the external design of the device to be easily changed according to users' preferences and enables the device to be stably enclosed and protected so as not to be easily separated from the case even through severe vibration and impact are applied to the device from the outside.

### CROSS-REFERENCE TO RELATED APPLICATION(S)

This application claims priority to Korean Patent Application No. 10-2015-0145648, filed on Oct. 19, 2015, in the Korean Intellectual Property Office, the disclosure(s) of which is(are) incorporated herein by reference in its(their) entirety.

### BACKGROUND OF THE INVENTION

Field of the Invention

The present invention relates to a case configured to be removably mounted to a wall with ease, and more particularly, to a removable device case in which a plurality of rails formed in a main body thereof is assembled to a sliding coupling member such that the case can be removably mounted on a wall surface with ease.

Description of the Related Art

In general, devices covered with cases, e.g. mobile phones use cases which are suitable for the fixed external structure thereof. Accordingly, it is necessary to purchase new mobile phones if a user intends to change the external design of the mobile phones.

Such a case for mobile phone may be replaced when the cover thereof is damaged or broken or the user intends to change the external design or color of a mobile phone according to preferences.

However, the case for mobile phone should be completely replaced with a new case for mobile phone in the event of the above situation, since its constituent front and rear covers are integrally formed. This may cause a financial burden.

In addition, a separate holder is required to hold a mobile phone when the mobile phone is used for the purpose of navigation in a vehicle interior. However, there is a problem in that the holder has to be installed in a stable and flat place and it is cumbersome to couple the mobile phone to the holder.

Accordingly, there is a need for an improved case for mobile phone which can have various aesthetic designs by easily changing a damaged or broken cover and replacing a cover to suit a user's preference.

In addition, there is a need for technology that can easily assemble various cases by establishing a standard size for each case in order to reduce man-hours, costs, and work time required to manufacture the cases according to the external appearances of mobile phones.

Meanwhile, Korean Patent No. 10-1371307 as the related art discloses a case for mobile phone to which a protective cover and an auxiliary cover are removably mounted. This technology may allow only a portion of the covers to be selectively used according to users' preferences.

However, similarly to the related art, the above technology may not resolve an issue relating to the provision of a separate holder such that a mobile phone is fixed thereto.

[Patent Document 1] Korean Patent No. 10-1371307 (Mar. 3, 2014)

### SUMMARY OF THE INVENTION

Accordingly, the present invention is directed to a removable device case that substantially obviates one or more problems due to limitations and disadvantages of the related art.

An object of the present invention is to provide a removable device case in which its main body having a plurality of rails is assembled to a sliding coupling member such that the case can be removably mounted to a wall with ease.

Another object of the present invention is to provide a removable device case that can easily hold a device by coupling a rail part, formed on one surface of a main body thereof, to a separate coupling member.

A further object of the present invention is to provide a standard-sized case capable of accommodating various types of devices by attaching a coupling member to a separate cover case.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the accompanying drawings.

In accordance with an aspect of the present invention, a removable device case includes a main body having an accommodation part formed on a front surface thereof to accommodate a device, the main body including a rail part having one or more rails arranged at predetermined intervals in a certain direction, and a sliding coupling member, one surface of which is attached to a wall while the other surface thereof is slidably coupled to the rail part of the main body.

The rail part may include a stepped portion formed such that the sliding coupling member is not separated therefrom.

The removable device case may further include an auxiliary plate connected to the main body, the auxiliary plate including a groove portion formed so as to correspond to a shape of each rail of the rail part.

The sliding coupling member may include a first plate, and at least two first rail engagement parts provided on one surface of the first plate, each of the first rail engagement parts including a head portion inserted into the associated rail of the rail part so as to be fitted into the stepped portion, and a connection post for connecting the head portion to the first plate.

The sliding coupling member may include a second plate, and at least one second rail engagement part provided on one surface of the second plate, and including a pair of rails longitudinally elongated, and protrusion ends protruding inward from tips of the respective rails by a predetermined length so as to be each fitted into the stepped portion.

The second rail engagement part may include one or more coupling protrusions formed on upper surfaces of the rails, and the auxiliary plate may include at least two seating protrusions spaced apart from each other by a predetermined distance such that the coupling protrusions are elastically coupled and seated to the seating protrusions.

The auxiliary plate may be a first auxiliary plate having the groove portion formed so as to correspond to the stepped portion of the rail part.

The auxiliary plate may be a second auxiliary plate further including a latch protrusion for preventing separation of the second sliding coupling member.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view illustrating a removable device case according to an embodiment of the present invention;

FIG. 2 is a partially enlarged view schematically illustrating a main body of the removable device case according to the embodiment of the present invention;

FIG. 3 is a perspective view schematically illustrating a first sliding coupling member of the removable device case according to the embodiment of the present invention;

FIG. 4 is a partially enlarged view schematically illustrating a first auxiliary plate of the removable device case according to the embodiment of the present invention;

FIG. 5 is a perspective view schematically illustrating a second sliding coupling member of the removable device case according to the embodiment of the present invention; and

FIG. 6 is a partially enlarged view schematically illustrating a second auxiliary plate of the removable device case according to the embodiment of the present invention.

### DETAILED DESCRIPTION OF EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present.

The terminology used in the specification of the present invention is for the purpose of describing particular embodiments only and is not intended to limit the invention. As used in the specification and the appended claims, the singular forms “a”, “an” and “the” are intended to include the plural forms as well, unless context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms, such as “part”, “unit”, “module”, etc., used in the specification of the present invention refer to units that process at least one function or operation, and these may be implemented by hardware, software, or a combination thereof.

Throughout the disclosure, like reference numerals refer to like parts throughout the various figures and embodiments of the present invention. The drawings are not necessarily to scale and in some instances, proportions may have been exaggerated in order to clearly illustrate features of the embodiments. In certain embodiments, description irrelevant to the present invention may be omitted to avoid obscuring appreciation of the disclosure.

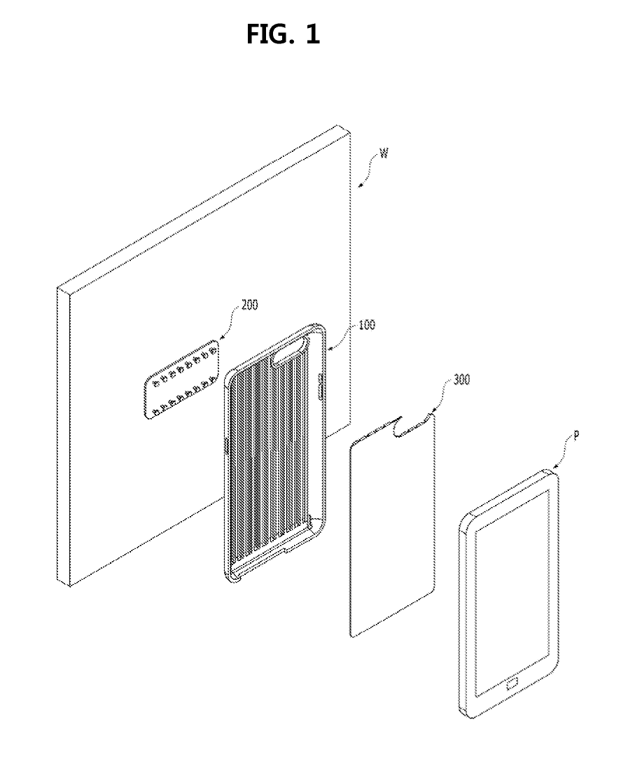

A removable device case according to exemplary embodiments of the present invention will be described below in more detail with reference to FIGS. 1 to 4.

FIG. 1 is an exploded perspective view illustrating a removable device case according to an embodiment of the present invention.

As illustrated in FIG. 1, the removable device case according to the embodiment of the present invention includes a main body 100 having an accommodation part which is formed on the front surface thereof to accommodate a device, and a sliding coupling member 200 which is connected to the rear surface of the main body 100 so as to be attached to any wall W.

The device may be any type of device accommodated in the main body 100. Although a mobile phone P is illustrated as an example of the device in the embodiment, the present invention is not limited thereto. For example, various types of devices may be applied to the present invention as long as they are covered with cases.

In addition, the wall W may be any place in which the main body 100 is mounted and held. Although a wall surface is illustrated as an example of the wall W in the embodiment, the present invention is not limited thereto. For example, the case may be mounted in any place for holding it, if necessary.

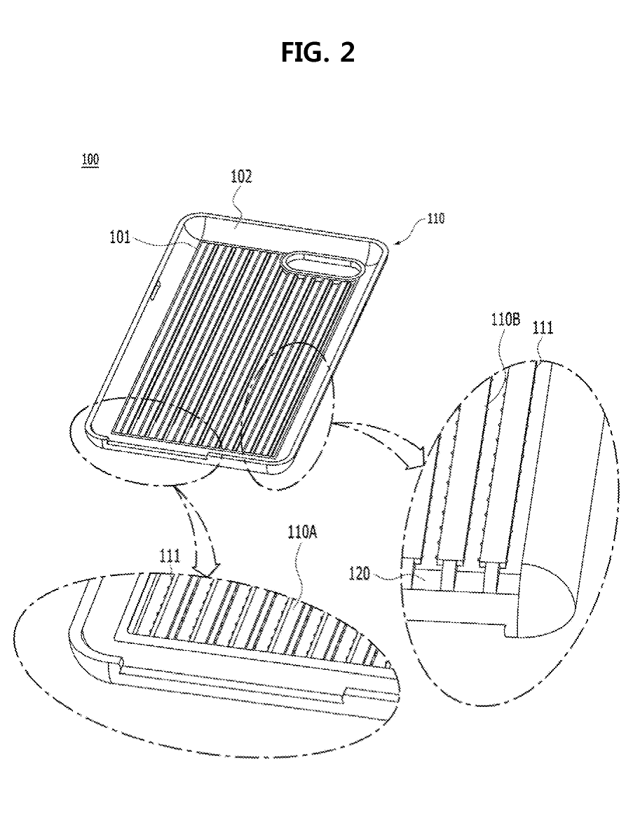

Hereinafter, the main body 100 according to the embodiment of the present invention will be described in more detail with reference to FIG. 2.

FIG. 2 is a partially enlarged view schematically illustrating the main body 100 of the removable device case according to the embodiment of the present invention.

As illustrated in FIG. 2, the main body 100 has an accommodation part which is formed on the front surface thereof to accommodate the device, and has a rail part 110 which is formed on one surface of thereof in a certain direction.

The main body 100 may be configured to have the same shape as a case for mobile phone in order to mount a device such as a mobile phone therein. Thus, the main body 100 includes a flat plate 101 which supports the rear surface of the device, and a plurality of side plates 102 which extends from the edges of the flat plate 101 to support the sides of the device.

The rail part 110 is formed in the flat plate 101 of the main body 100 and has rails which are longitudinally cut and are arranged at regular intervals. The rail part 110 is coupled to a sliding coupling member 200 or 400 which will be described later.

The direction in which the rail part 110 (specifically, the rails) is formed is illustrated as the longitudinal direction of the main body 100 in the embodiment, but the present invention is not limited thereto. For example, the rails of the rail part 110 may be formed in various directions.

The sliding coupling member 200 or 400 is inserted into the opened side of the rail part 110, moves along the rail part 110, and is then fixed at the closed side thereof.

The rail part 110 (i.e., the rails of the rail part 110) may be divided into rail front parts 110A and rail rear parts 110B, which have different widths. That is, the rail front parts 110A has a smaller width than the rail rear parts 110B, and each has a cross-sectional shape such as “ [symbol] ” so as to have a stepped portion of a certain height. Accordingly, the sliding coupling member 200 or 400 has a shape corresponding to the stepped portion, and may slide in the state in which the sliding coupling member is coupled to the rail front parts 110A. Therefore, the stepped portion serves as a guide for movement of the sliding coupling member 200 or 400, and simultaneously prevents the sliding coupling member 200 or 400 from being separated from the rail front parts 110A.

In addition, a plurality of latch portions 111 is formed on the side of the stepped portion in the state in which they are spaced apart from each other by a predetermined distance. The sliding coupling member 200 or 400 is elastically moved while being caught by the latch portions 111, thereby enabling the movement distance of the sliding coupling member 200 or 400 to be restricted by a predetermined distance.

Meanwhile, in order to smoothly insert the sliding coupling member 200 or 400 into the rail part 110, insertion guide portions 120 are formed at one end of the rail part 110 (specifically, at the end portions of the rail rear parts 110B) and have a larger distance than each rail of the rail part 110.

The sliding coupling member 200 or 400 is slidably coupled to the rail part 100 so that the main body 100 may be mounted to the sliding coupling member 200 or 400, but the sliding coupling member 200 or 400 may vary in various forms. The sliding coupling member 200 or 400 is preferably configured as a protrusion type of first sliding coupling member 200 or a rail type of second sliding coupling member 400.

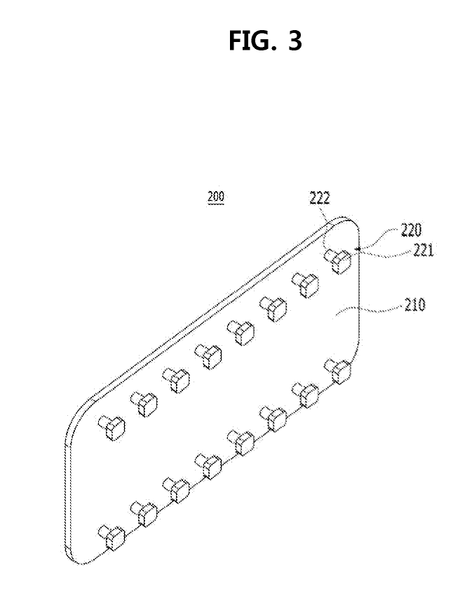

First, the first sliding coupling member 200 will be described in more detail with reference to FIG. 3. FIG. 3 is a perspective view schematically illustrating the first sliding coupling member 200 of the removable device case according to the embodiment of the present invention.

The first sliding coupling member 200 includes a first plate 210, and the first plate 210 may be attached to the wall W while adhesive is applied to one surface of the first plate 210. First rail engagement parts 220 for connection with the main body 100 are provided on the other surface of the first plate 210.

The first sliding coupling member 200 includes at least two first rail engagement parts 220. The first rail engagement parts 220 are slidably coupled to the associated rails of the rail part 110 provided in the rear surface of the main body 100, thereby enabling the first sliding coupling member 200 to be coupled to the main body 100.

Each of the first rail engagement parts 220 includes a head portion 221 which is inserted into the associated rail of the rail part 110 such that the head portion 221 may be slidably seated to the stepped portion of the rail part 110, and a connection post 222 for connecting the head portion 221 to the first plate 210. The head portion 221 has a longitudinal width greater than the cross-sectional width of the connection post 222.

Accordingly, the head portion 221 is inserted into the associated rail rear part 110B and is then caught by the stepped portion so as not to be separated therefrom. The connection post 222 has a smaller width than the head portion and is connected to the first plate 210 through a slit between one stepped portion and another stepped portion, thereby enabling the first rail engagement part 220 to smoothly slide.

Meanwhile, an auxiliary plate 300 or 500 serves to prevent the rail part 110 from rolling, and may be fixedly inserted into an insertion groove formed in the main body 100.

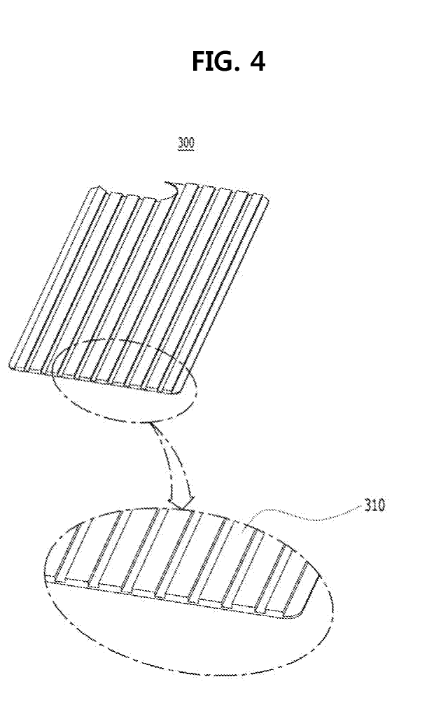

FIG. 4 is a partially enlarged view schematically illustrating a first auxiliary plate 300 of the removable device case according to the embodiment of the present invention.

The first auxiliary plate 300 is a plate which is fitted toward the rail front parts 110A of the main body 100. The first auxiliary plate 300 serves to prevent the rolling of the rail part 110 when it moves along the rail part 110, and at the same time to enhance the durability of the rail part 110.

The first auxiliary plate 300 has groove portions 310, each having a width corresponding to the size of the stepped portion of each rail front part 110A, and is inserted into the insertion groove of the main body 100. That is, the groove portion 310 has a shape corresponding to the stepped portion of the rail part 110 so as to be engaged therewith, thereby preventing the rolling of the rail part 110 when the first rail engagement parts 220 move along the rail part 110.

Alternatively, the main body 100 may also be formed integrally with the first auxiliary plate 300.

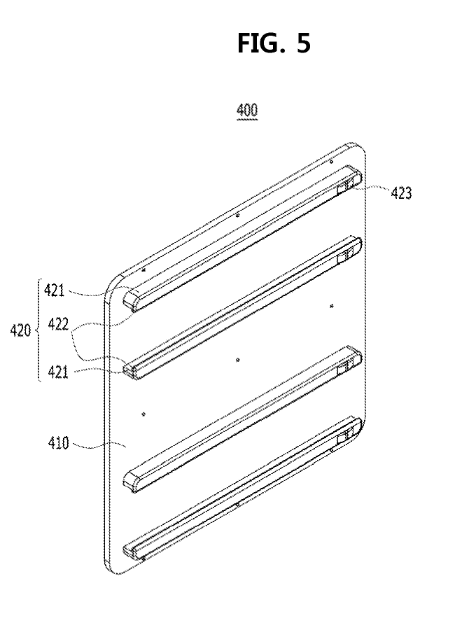

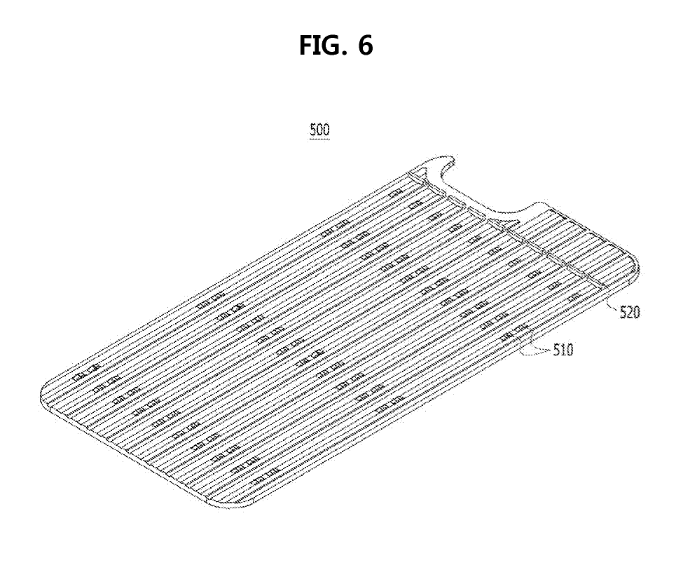

FIG. 5 is a perspective view schematically illustrating the second sliding coupling member of the removable device case according to the embodiment of the present invention. FIG. 6 is a partially enlarged view schematically illustrating a second auxiliary plate of the removable device case according to the embodiment of the present invention.

As illustrated in FIG. 5, one surface of the second sliding coupling member 400 according to the embodiment of the present invention may be attached to the wall W by adhesive, and the other surface thereof may be formed with a pair of second rail engagement parts 420 which faces with each other such that the second sliding coupling member 400 may be slidably coupled to the rail part 110 formed in the main body 100.

Each of the second rail engagement part 420 is configured of a pair of two rails. The rails are slidably coupled to the rail part 110 such that the second sliding coupling member 400 may be slidably coupled to the main body 100.

The second rail engagement part 420 includes rails 421 which are longitudinally elongated, and protrusion ends 422 which protrude inward from the tips of the respective rails 421 by a predetermined length. The protrusion ends 422 move while being engaged with the stepped portions of the rail part 110 of the main body 100, whereby the second rail engagement part 420 may smoothly slide while being not separated from the rail part 110 of the main body 100.

Meanwhile, the second rail engagement part 420 may further include coupling protrusions 423 for allowing the elastic coupling with a second auxiliary plate 500 which will be described later. The coupling protrusions 423 may be elastically engaged with seating protrusions 510 formed on the second auxiliary plate 500 so as to restrict the movement of the second rail engagement parts 420.

As illustrated in FIG. 6, the second auxiliary plate 500 according to the embodiment of the present invention is fastened toward the rail front parts 110A of the main body 100. The second auxiliary plate 500 serves to prevent the rolling of the rail part 110, and preferably has groove portions, each corresponding to the stepped portion of the rail part 110 and being longitudinally formed, similarly to the first auxiliary plate 300.

Meanwhile, the second auxiliary plate 500 may further include seating protrusions 510, which are formed on the protruding surfaces of the groove portions thereof and are elastically coupled to the coupling protrusions 421 of the second rail engagement parts 420 of the second sliding coupling member 400.

That is, in order to temporarily restrict the movement position of the second auxiliary plate 500 relative to the second sliding coupling member 400 when the second auxiliary plate 500 is coupled to the main body 100, the coupling protrusions 421 of the second rail engagement parts 420 elastically cross over the seating protrusions 510, which are spaced apart from each other by a predetermined distance in the second auxiliary plate 500, and are then seated between the seating protrusions 510.

The plurality of seating protrusions 510 may be formed on the second auxiliary plate 500 so as to be spaced apart from each other by a predetermined distance. Alternatively, the seating protrusions 510 may be formed on the second rail engagement parts 420 and the coupling protrusions 421 may be formed on the second auxiliary plate 500.

In addition, in order to prevent the second sliding coupling member 400 from being separated from the rail part 110, the second auxiliary plate 500 preferably includes latch protrusions 520 formed at the end thereof.

Through such a structure, the device case of the present invention can easily hold the device by coupling the main body 100 to the sliding coupling member 200 or 400 attached to the wall W.

In addition, the present invention can provide a standard-sized case which is usable even when the case does not have the same size as the external appearance of the device, in such a way to attach the sliding coupling member 200 to a separate cover case and couple the main body 100 thereto.

Furthermore, the removable device case of the present invention may also be provided in various forms. For example, the main body 100 may be formed integrally with the auxiliary plate 300 or 500, and the rail engagement parts 220 or 420 of the sliding coupling member 200 or 400 may be coupled to the rails of the rail part.

As is apparent from the above description, the removable device case according to the present invention provides the following effects.

The present invention provides a device case that can be removably mounted to a wall with ease by coupling its main body having a plurality of rails to a sliding coupling member, which is attached to the wall and has protrusions corresponding to the rails, in an assembled manner.

The present invention provides a case coupling structure that enables the external design of a device to be easily changed according to users' preferences and enables the device to be conveniently carried and held, while the device is stably enclosed and protected so as not to be easily separated from the case even through severe vibration and impact are applied to the device from the outside.

Although embodiments have been described with reference to a number of illustrative embodiments thereof, it should be understood that numerous other modifications and applications may be devised by those skilled in the art that will fall within the intrinsic aspects of the embodiments. More particularly, various variations and modifications are possible in concrete constituent elements of the embodiments. In addition, it is to be understood that differences relevant to the variations and modifications fall within the spirit and scope of the present disclosure defined in the appended claims.

1. A removable device case comprising:
a main body having an accommodation part formed on a front surface thereof to accommodate a device, the main body comprising a rail part having one or more rails arranged at predetermined intervals in a same direction;
a sliding coupling member, one surface of which is configured to be attached to a wall while the other surface thereof has a rail engagement part formed to be slidably coupled to the rail part of the main body; and
an auxiliary plate configured to be connected to the main body, the auxiliary plate comprising a groove portion formed in such a way that the groove portion corresponds to a shape of each rail of the rail part arranged in the same direction,
wherein the main body and the sliding coupling member are separately configured such that the sliding coupling member is slidably coupled to or removed from the main body by a user.

2. The removable device case according to claim 1, wherein the rail part comprises a stepped portion formed such that the sliding coupling member slidably moving along the rail part of the main body is not separated therefrom.

3. (canceled)

4. The removable device case according to claim 2, wherein the sliding coupling member comprises:
a first plate; and
at least two first rail engagement parts provided on one surface of the first plate, each of the first rail engagement parts comprising a head portion inserted into the associated rail of the rail part so as to be fitted into the stepped portion, and a connection post for connecting the head portion to the first plate.

5. The removable device case according to claim 2, wherein the sliding coupling member comprises:
a second plate; and
at least one second rail engagement part provided on one surface of the second plate, and comprising a pair of rails longitudinally elongated, and protrusion ends protruding inward from tips of the respective rails by a predetermined length so as to be each fitted into the stepped portion.

6. The removable device case according to claim 5, wherein the second rail engagement part comprises one or more coupling protrusions formed on upper surfaces of the rails, and the auxiliary plate comprises at least two seating protrusions spaced apart from each other by a predetermined distance such that the coupling protrusions are elastically coupled and seated to the seating protrusions.

7. The removable device case according to claim 2, wherein the auxiliary plate is a first auxiliary plate having the groove portion formed so as to correspond to the stepped portion of the rail part.

8. The removable device case according to claim 6, wherein the auxiliary plate is a second auxiliary plate further comprising a latch protrusion for preventing separation of the sliding coupling member.

9. The removable device case according to claim 1, wherein the accommodation part and the rail part are integrally formed in the main body.

10. The removable device case according to claim 1, wherein one end of the rail part of the main body is opened for insertion or removal of the sliding coupling member, and the other end of the rail part is closed for fixing of the inserted sliding coupling member.

11. The removable device case according to claim 1, wherein the main body includes at least one insertion guide portion formed to insert the sliding coupling member into the rail part.

12. The removable device case according to claim 11, wherein the at least one insertion guide portion is formed at one end of the rail part.
